(19) United States
(12) Patent Application Publication
(10) Pub. No.: US 2021/0224060 A1
(43) Pub. Date: Jul. 22, 2021

(54) FLASHING FIRMWARE VIA OVER-THE-AIR ENABLED DEVICES

(71) Applicant: Carrier Corporation, Palm Beach Gardens, FL (US)

(72) Inventors: Sumanth Kumar Mukundala, Hyderabad, Telangana (IN); Vasudevan Raghavan, Hyderabad, Telangana (IN)

(21) Appl. No.: 17/059,065

(22) PCT Filed: Sep. 3, 2019
(86) PCT No.: PCT/US2019/049314

§ 371 Date: Nov. 25, 2020

(30) Foreign Application Priority Data
Sep. 7, 2018 (IN) 201811033663

(51) Int. Cl. G06F 8/654

(52) U.S. Cl. CPC G06F 8/654; G06F 8/71

(57) ABSTRACT

A system for executing a flash of a firmware update is provided. The system includes a server subsystem, a cloud service, and devices. The server subsystem of the system connects to the cloud service. The server subsystem automatically detects the firmware update on the cloud service. The server subsystem executes the flash of the firmware update to each of the one or more devices

### BACKGROUND

At present, firmware updates a conventional camera system including multiple camera located throughout a facility require manual efforts. That is, a technician must establish and confirm communications between a facility digital video recorder and the multiple cameras and then perform upgrade process via a manual firmware process, an end user software application, and/or a bulk firmware application upgrade. Conventional camera systems and these manual upgrade process include the disadvantages of being very time consuming (each camera requires local individual attention by a technicians), cost prohibitive (costs increase based on time spent by technicians), and extended down time (the camera are not operation until upgrade is verified).

First example, if the firmware has to be flashed to cameras, a customer is first updated with a new firmware notification either through an email or a message to a client. The firmware is manually downloaded to a facility digital video recorder via the link provided in the email by a customer/client or via a client technician manually connecting to a cloud server. After downloading, the client technician manually checks a software application of the facility digital video recorder and any interconnected cameras. The client technician further manually clicks a firmware icon of the software application and selects to upgrade all connected devices. All connected devices must be networked on the same local area network to receive this manually firmware upgrade; otherwise, the client technician must physically visit each camera.

### BRIEF DESCRIPTION

In accordance with one or more embodiments, a system for executing a flash of a firmware update is provided. The system includes a server subsystem, a cloud service, and devices. The server subsystem of the system connects to the cloud service. The server subsystem automatically detects the firmware update on the cloud service. The server subsystem executes the flash of the firmware update to each of the one or more devices.

In accordance with one or more embodiments or the above system embodiment, the firmware update can be stored on a server of the cloud service.

In accordance with one or more embodiments or any of the above system embodiments, the server subsystem can detect the firmware update by comparing a previous firmware version number to a version number of the firmware update.

In accordance with one or more embodiments or any of the above system embodiments, the server subsystem can detect the firmware update by comparing a date of a previous firmware to an origination date of the firmware update.

In accordance with one or more embodiments or any of the above system embodiments, the server subsystem can send a notification to the service technician of the engineering or support team when the firmware update is available on the cloud service.

In accordance with one or more embodiments or any of the above system embodiments, the flash of the firmware update can be initiated in response to a notification that the firmware update is available on the cloud service.

In accordance with one or more embodiments or any of the above system embodiments, the flash of the firmware update can be executed from the cloud service to the one or more devices through the server subsystem.

In accordance with one or more embodiments or any of the above system embodiments, the server subsystem can be connected to the one or more devices through Bluetooth.

In accordance with one or more embodiments or any of the above system embodiments, a first device of the one or more devices can include a wireless security camera with an internal control board therein.

In accordance with one or more embodiments or any of the above system embodiments, the server subsystem can include a built-in Bluetooth transceiver or a Bluetooth dongle.

In accordance with one or more embodiments, any of the above system embodiments can be implemented as a method and/or computer program product.

### BRIEF DESCRIPTION OF THE DRAWINGS

The following descriptions should not be considered limiting in any way. With reference to the accompanying drawings, like elements are numbered alike:

FIG. 1 depicts a system for flashing firmware in accordance with one or more embodiments;

FIG. 2 depicts a process flow of a system in accordance with one or more embodiments;

FIG. 3 depicts a schematic flow of the system for flashing firmware in accordance with one or more embodiments; and

FIG. 4 depicts a schematic flow of the system for flashing firmware in accordance with one or more embodiments.

### DETAILED DESCRIPTION

A detailed description of one or more embodiments of the disclosed system and method are presented herein by way of exemplification and not limitation with reference to the Figures.

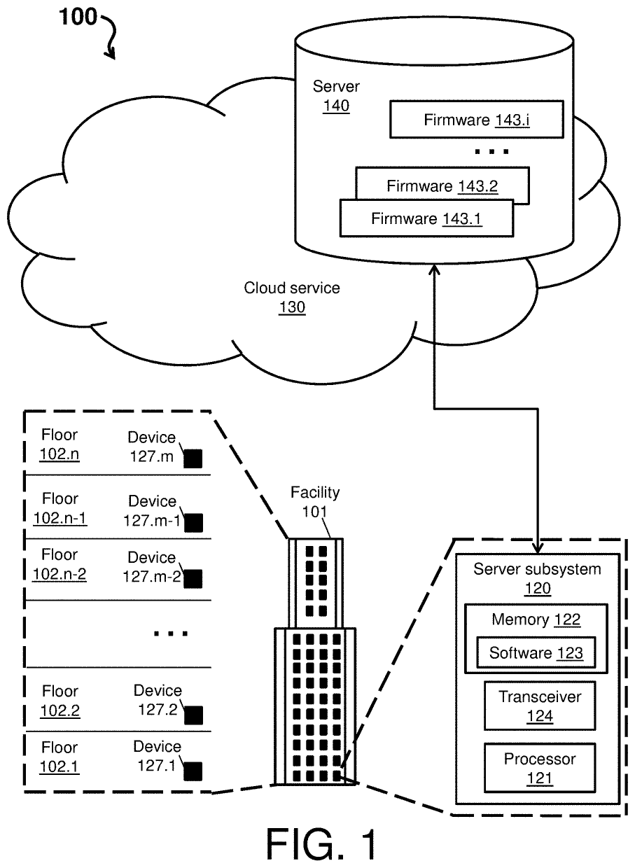

FIG. 1 depicts a schematic illustration of a system 100 for implementing flashing firmware via over-the-air (OTA) enabled devices in accordance with one or more embodiments, which can be realized as processor-implemented methods and/or computer program products. The system 100 overlays a facility 101. The facility 101 can be any building, structure, campus, park, complex, parking facility, amusement park, stadium, etc. or combination thereof. As shown in FIG. 1, for example, the facility 101 is a building that includes one or more floors 102.1-102.n, where “n” is an integer greater than zero. The facility 110 is utilized as an illustration of a complexity of the system 100, in that the system 110 can stretch across a vast area in any direction, which exacerbates the disadvantages of the conventional camera system described herein.

The system 100 and elements therein may take many different forms and include multiple and/or alternate components and facilities. The system 100 is only one example and is not intended to suggest any limitation as to the scope of use or operability of embodiments described herein (indeed additional or alternative components and/or implementations may be used). While single items are illustrated for the system 100 (and other items), these representations are not intended to be limiting and thus, any items may represent a plurality of items.

The system 100 includes a server subsystem 120. The server subsystem 120 is a computing device that is improved upon by the operation and functionality of the embodiments described herein. The server subsystem 120 includes a processor 121 and a memory 122 with software 123 (e.g., flashing firmware application) stored thereon. The processor 121 includes any processing hardware, software, or combination of hardware and software (utilized by the server subsystem 120) that carries out the computer readable program instructions by performing arithmetical, logical, and/or input/output operations. Examples of the processor 121 include, but are not limited to an arithmetic logic unit, which performs arithmetic and logical operations; a control unit, which extracts, decodes, and executes instructions from a memory; and an array unit, which utilizes multiple parallel computing elements.

The memory 122 is an example of a tangible device that retains and stores computer readable program instructions or at least one program product (e.g., the software 123) for use by the processor 121 to carry out the operations of embodiments herein. The memory 122 can include a variety of computer system readable media. Such media may be any available media that is accessible and it includes both volatile and non-volatile media, removable and non-removable media.

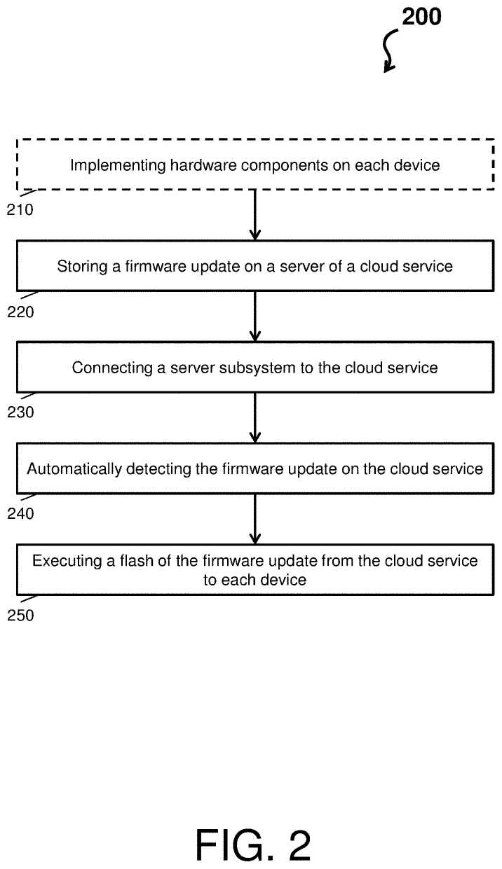

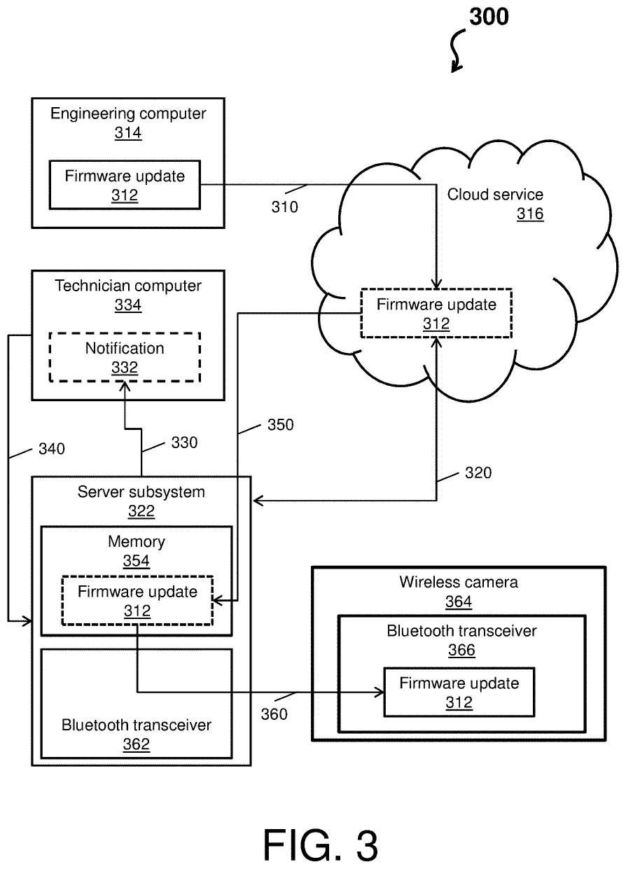

The software 123 is a set of computer readable instructions stored in the memory 122, respectively, along with an operating system, one or more application programs, other program modules, and program data. In this regard, the processor 121 executes the software 123 on the memory 122, thereby performing one or more processes defined herein. The software 123, more particularly, causes the server subsystem 120 to implement flashing firmware via OTA enabled devices, such as is described herein with reference to FIGS. 2-3. Flashing firmware can include utilizing a transceiver 124 of the server subsystem 120. The transceiver 124 is circuitry including a transmitter and a receiver for communications to devices external to the server subsystem 120. An example of the transceiver 124 includes a built-in Bluetooth transceiver or a Bluetooth dongle. The Bluetooth dongle can include a universal serial bus network adapter that enables the server subsystem 120 to communicate with Bluetooth devices present internally in one or more devices 127.1-127.m (e.g., OTA enabled devices). Note that when a Bluetooth range criteria (e.g., usually 100 meters) is not met between the server subsystem 120 and the one or more devices 127.1-127.m (e.g., when the distance is more than 100 meters), a Bluetooth range extender and/or range multiplier can be utilized to establish communications and increase the Bluetooth range criteria (e.g., up to 3 kilometers). In this scenario, the one or more devices 127.1-127.m can be paired to a nearest Bluetooth extender and/or range multiplier so that the executing the firmware flash can be initiated.

The server subsystem 120 at least communicates with the one or more devices 127.1-127.m, where “m” is an integer greater than zero. In accordance with one or more embodiments, the server subsystem 120 communicates with the one or more devices 127.1-127.m by Wi-Fi and/or Bluetooth (e.g., all of the one or more devices 127.1-127.m are connected to the server subsystem 120 through Bluetooth). The server subsystem 120 can also manage and monitor some or all of the one or more devices 127.1-127.m through hard wired connections, Wi-Fi, and Bluetooth.

As shown in FIG. 1, for example, a location configuration can include each of the one or more devices 127.1-127.m corresponding to each of the one or more floors 102.1-102.n; however, this location configuration is not limited thereto. The location configuration is utilized as another illustration of the complexity of the system 100, in that placements of one or more devices 127.1-127.m can stretch, repeat, and/or be randomly set across the vast area of the facility 101, which further exacerbates the disadvantages of the conventional camera system described herein.

The one or more devices 127.1-127.m can be any computing device for operating firmware (as described herein) and interacting with the system 100 and are improved upon by the operation and functionality of the embodiments described herein. The one or more devices 127.1-127.m can include similar elements to that of the server subsystem 120. An example of the one or more devices 127.1-127.m is an OTA enabled device as described herein. The OTA enabled device is only one example of the one or more devices 127.1-127.m and is not intended to suggest any limitation as to the scope of use or operability of embodiments described herein (indeed additional or alternative components and/or implementations may be used). An OTA enabled device and elements therein may take many different forms and include multiple and/or alternate components and facilities. For instance, the OTA enabled device can be any and/or employ any number and combination of computing devices and networks utilizing various communication technologies, as described herein.

In accordance with one or more embodiments, the OTA enabled device can include a wireless security camera that transmits a video and/or audio signal to the server subsystem 120 and communicates/receives data/firmware via a wireless receiver through a radio band (e.g., a wireless technology standard for exchanging data over short distances, such as Bluetooth). The OTA enabled device can require at least one wire for power or be battery-powered. Further, for each of the one or more devices 127.1-127.m that do not already include built-in Bluetooth connectivity, an existing control board therein can have a wireless receiver or Bluetooth chip installed thereon. Thus, for example, a Bluetooth chip is installed of each of the one or more devices 127.1-127.m, thereby providing a technical effect and benefit of utilizing minimal hardware (e.g., add-on to the existing control board).

The system 100 includes a cloud service 130. The cloud service 130 includes a sever 140 hosting firmware 143.1-143.i thereon, where “i” is an integer greater than zero. The firmware 143.1-143.i includes new or modified internal software versions for the one or more devices 127.1-127.m. In this regard, the firmware 143.1-143.i can include control board software, reader software, interface software, camera software, communication software, etc. The firmware 143.1-143.i can be ordered according to versions.

The server subsystem 120 and the sever 140 communicate via the cloud service 130, such as by Wi-Fi, cellular, broadband, and Bluetooth technologies. The cloud service 130 can be a distributed cloud computing environment (e.g., a cloud distribution system) where tasks are performed by remote processing devices (e.g., the sever 140) that are linked through a communications within the cloud service 130. The cloud service 130 and the server 140 can include hardware and/or software that is similar to the server subsystem 120 described herein. In the cloud service 130, the firmware 143.1-143.i can be located in both local and remote computer system storage media (e.g., the sever 140) including memory storage devices. The cloud service 130 and the server 140 are computing devices that are improved upon by the operation and functionality of the embodiments described herein.

Note that any Bluetooth chip installed in the one or more devices 127.1-127.m in camera and any Bluetooth extender hardware can communicate through a secure protocol, so that if a third party source tries to access the one or more devices 127.1-127.m and/or the server subsystem 120 then communication will not be established. That is, only registered devices of the one or more devices 127.1-127.m can communicate upon verification.

FIG. 2 depicts a process flow 200 of the system 100 for flashing firmware via OTA enabled devices in accordance with one or more embodiments. More particularly, the process flow 200 is a method of flashing the firmware 143.1-143.i via the one or more devices 127.1-127.m implemented by the system 100. As described herein, the flashing firmware can be considered an OTA device firmware upgrade process, e.g., such that a boot load mechanism (of the server subsystem 120) utilizes a wireless link to update firmware on a target devices (e.g., the one or more devices 127.1-127.m). The boot load mechanism can be a program that starts a sequence to load other data and programs (e.g., the firmware 143.1-143.i) which are then executed from RAM of the one or more devices 127.1-127.m.

The process flow 200 begins at dashed block 210, where hardware components are implemented on each of the one or more devices 127.1-127.m. Note that dashed block 210 is for each of the one or more devices 127.1-127.m that do not already include the hardware components. The hardware components include a wireless receiver (e.g., a Bluetooth chip) enabled to communicate across one or more radio bands (e.g., such as Bluetooth). Thus, for example, a Bluetooth chip is installed on an existing control board of each of the one or more devices 127.1-127.m. With each of the one or more devices 127.1-127.m now including the hardware component, the process flow 200 proceeds to block 220.

At block 220, the firmware 143.1-143.i is stored on the server 140. The firmware 143.1-143.i can be manually loaded or transferred (e.g., by a service technician of an engineering or support team) to the cloud server 130. In accordance with one of more embodiments, a new/upgraded version of the firmware 143.1-143.i is stored on the cloud, herein referred to as a firmware update.

At block 230, the server subsystem 120 connects to the cloud service 130. The server subsystem 120 can connect to the cloud service by a Wi-Fi, cellular, broadband, and/or Bluetooth connection. At block 240, the system 100 automatically detects the firmware update. In accordance with one or more embodiments, the server subsystem 120 itself determines that the firmware update is available on the cloud serviced 130 and sends a notification to the service technician of the engineering or support team. The server subsystem 120 can make the determination that the firmware update is available on the cloud serviced 130 by comparing a previous firmware version number to a version number of the firmware update and/or by comparing a date (e.g., an install date or an origination date) of a previous firmware to an origination date of the firmware update.

In general, a notification is a mechanism for delivering and/or identifying information or non-existence of the information (e.g., availability of a firmware update) to the service technician of the engineering or support team. Examples of notification mechanisms may include, but are not limited to, text messaging, audio alerts (e.g., telephone calls, cellphone calls, VoIP calls, voicemails, loudspeaker announcements, etc.), electronic mail, desktop alerts (e.g., dialog, balloon, modal window, etc.), pager, instant messaging, and the like.

At block 250, a flash of the firmware update is executed for the one or more devices 127.1-127.m. The flash of the firmware update can be executed from the cloud service 130 to the one or more devices 127.1-127.m, such as through the server subsystem 120 (e.g., as all the one or more devices 127.1-127.m are connected to the server subsystem 120 through Bluetooth). For example, the transceiver 124 of the server subsystem 120 can communicate the firmware update while the server subsystem 120 is operating a boot loader mechanism. The service technician of the engineering or support team can initiate the flash of the firmware update in response to the notification. For successfully flashed firmware, a confirmation message can be sent to the service technician. If any of the one or more devices 127.1-127.m device failed to flash the firmware update, that the device can send a service notification to the service technician for analysis.

FIG. 3 depicts a schematic flow 300 of the system 300 for flashing firmware in accordance with one or more embodiments. The schematic flow 400 begins at operation 310, which includes a firmware update 312 being sent by an engineering computer 314 to a cloud service 316. The engineering computer 314 can be include the same components as any computing system described herein. The engineering computer 314 is operated by a software engineer who builds and modifies firmware. In this regard, the firmware update 312 is a software patch created by the software engineer. The cloud service 316 is similar to the cloud service 130 of FIG. 1.

At operation 320, a server subsystem 322 (e.g., the server subsystem 120 of FIG. 1) connects to the cloud service 316 and automatically detects the firmware update 312. At operation 330, the server subsystem 322 sends a notification 332 to a technician computer 334. The technician computer 334 can be include the same components as any computing system described herein. In accordance with one or more embodiments, the technician computer 334 can be a mobile phone or laptop computer.

At operation 340, the technician computer 334 sends an initiation command to the server subsystem 322. The service technician utilizing the technician computer 334 initiate a flash of the firmware update 312 in response to the notification. In response, at operation 350, the server subsystem 322 downloads the firmware update 312 from the cloud service 316 to the memory 354.

At operation 360, the server subsystem 322 utilizes a Bluetooth transceiver 362 to provide the firmware update 312 to a wireless camera 364 via a Bluetooth transceiver 366 therein.

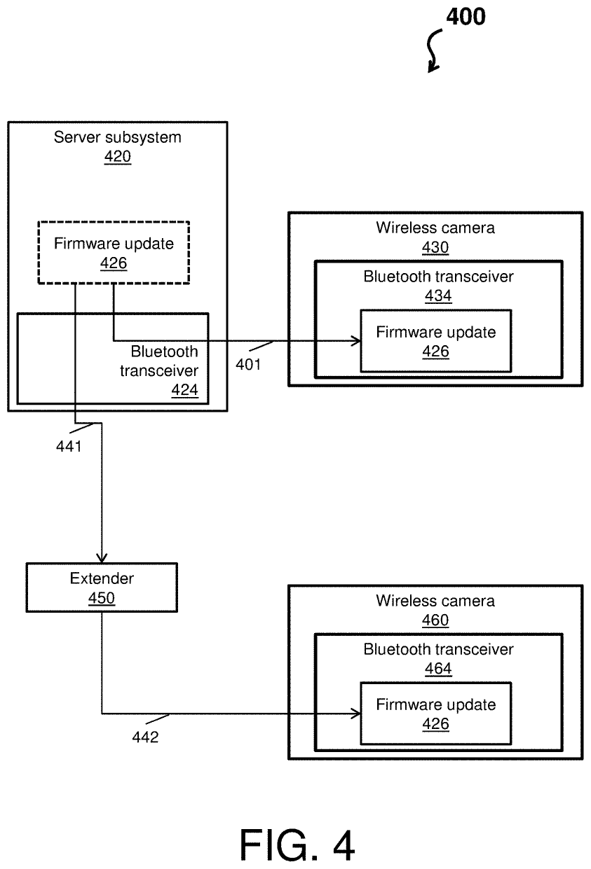

FIG. 4 depicts a schematic flow 400 of the system for flashing firmware in accordance with one or more embodiments. As shown in FIG. 4, the schematic flow 400 begins at operation 401, which includes a server subsystem 420 utilizing a Bluetooth transceiver 424 to provide a firmware update 426 to a wireless camera 430 via a Bluetooth transceiver 434. At operations 441 and 442, the server subsystem 420 utilizing the Bluetooth transceiver 424 to communicate to an extender 450 (e.g., a Bluetooth range extender and/or range multiplier), which further provides the firmware update 426 to a wireless camera 460 via a Bluetooth transceiver 464. Note that if the extender 450 is trapped, a notification can be to the service technician.

In view of the above, one or more embodiments of the disclosed system and method have many advantages over conventional camera systems. For instance, in the conventional camera system, all devices (e.g., i.e. facility digital video recorder, cameras, etc.) need to connect to a network before a firmware upgrade process can be initiated. Considering a case of 30 floors in a high rise building and assuming a server room with a facility digital video recorder therein is at first floor, all the cameras connected to all 30 floors will be connected to recorder through an extensive cabling network. Assuming 30th floor camera(s) must flashed with the new firmware file, a significant reduction in speed of data transmission from the facility digital video recorder to the camera(s) connected at 30th floor occurs due to the length of the cabling network. This reduction in speed can cause the firmware upgrade process to fail.

To overcome these drawbacks in conventional camera systems, the system 100 implements flashing firmware via OTA therefore bypasses the cabling network. The technical effect and benefits of the system 100, thus, include at least a firmware upgrade process initiated on all cameras installed at various locations in a shorter time compared to the cabling network based firmware flash procedure; flashing multiple firmware files various camera modules simultaneously; and implementing Bluetooth enabled device communication data transfer at a faster rate compared to the conventional camera systems.

In addition to the above technical effects and benefits, the system 100 can further provide video streaming. That is, where video streaming would be a challenge for conventional camera systems, the system 100 bypasses the cabling network and uses Bluetooth connections for a secure Bluetooth enabled surveillance system. In this regard, the system 100 performs video streaming over Bluetooth by establishing point to multi point topology, thereby further establishing a Bluetooth infrastructure using a complex network scheme.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system for executing a flash of a firmware update, the system comprising a server subsystem, a cloud service, and one or more devices, the system configured to perform:
Connecting, by the server subsystem, to the cloud service;
Automatically detecting, by the server subsystem, the firmware update on the cloud service; and
executing, by the server subsystem, the flash of the firmware update to each of the one or more devices.

2. The system of claim 1, wherein the firmware update is stored on a server of the cloud service.

3. The system of claim 1, wherein the server subsystem detects the firmware update by comparing a previous firmware version number to a version number of the firmware update.

4. The system of claim 1, wherein the server subsystem detects the firmware update by comparing a date of a previous firmware to an origination date of the firmware update.

5. The system of claim 1, wherein the server subsystem sends a notification to the service technician of the engineering or support team when the firmware update is available on the cloud service.

6. The system of claim 1, wherein the flash of the firmware update is initiated in response to a notification that the firmware update is available on the cloud service.

7. The system of claim 1, wherein the flash of the firmware update is executed from the cloud service to the one or more devices through the server subsystem.

8. The system of claim 1, wherein the server subsystem is connected to the one or more devices through Bluetooth.

9. The system of claim 1, wherein a first device of the one or more devices comprises a wireless security camera with an internal control board therein.

10. The system of claim 1, wherein the server subsystem comprises a built-in Bluetooth transceiver or a Bluetooth dongle.

11. A method for executing a flash of a firmware update, the method being executable by a system comprising a server subsystem, a cloud service, and one or more devices, the method comprising:
connecting, by the server subsystem, to the cloud service;
automatically detecting, by the server subsystem, the firmware update on the cloud service; and
executing, by the server subsystem, the flash of the firmware update to each of the one or more devices.

12. The method of claim 11, wherein the firmware update is stored on a server of the cloud service.

13. The method of claim 11, wherein the server subsystem detects the firmware update by comparing a previous firmware version number to a version number of the firmware update.

14. The method of claim 11, wherein the server subsystem detects the firmware update by comparing a date of a previous firmware to an origination date of the firmware update.

15. The method of claim 11, wherein the server subsystem sends a notification to the service technician of the engineering or support team when the firmware update is available on the cloud service.

16. The method of claim 11, wherein the flash of the firmware update is initiated in response to a notification that the firmware update is available on the cloud service.

17. The method of claim 11, wherein the flash of the firmware update is executed from the cloud service to the one or more devices through the server subsystem.

18. The method of claim 11, wherein the server subsystem is connected to the one or more devices through Bluetooth.

19. The method of claim 11, wherein a first device of the one or more devices comprises a wireless security camera with an internal control board therein.

20. The method of claim 11, wherein the server subsystem comprises a built-in Bluetooth transceiver or a Bluetooth dongle.
